(19) United States
(12) Patent Application Publication
(10) Pub. No.: US 2015/0042620 A1
(43) Pub. Date: Feb. 12, 2015

(54) DISPLAY DEVICE

(71) Applicant: Funai Electric Co., Ltd., Osaka (JP)

(72) Inventor: Daisuke YAMADA, Daito-shi (JP)

(21) Appl. No.: 14/445,188

(22) Filed: Jul. 29, 2014

(30) Foreign Application Priority Data
Aug. 9, 2013 (JP) 2013-166412

(51) Int. Cl. G06F 3/0488; G06F 3/042

(52) U.S. Cl. CPC G06F 3/04883; G06F 3/042
USPC 345/175

(57) ABSTRACT

A display device includes a detecting unit detecting an object in space in a direction of video output and deducing space information of the object, an operating surface setting unit using an operating surface setting object in the space in the direction of video output to create a virtual operating surface corresponding to a screen of the display unit, an input screen processing unit generating an image signal to draw on the screen a detection point indicating the position of a finger constituting the object, and an input point determining unit identifying that the finger within the frame of the operating surface moved from the operator side toward the display unit and reached the operating surface and using the detection point regarding the arrival position of the finger that arrived at the operating surface to determine an input point indicating that a single point on the operating surface was selected.

### BACKGROUND OF THE INVENTION

1. Field of the Invention

The present invention relates to a display device.

2. Description of the Related Art

Many display devices typified by televisions are remotely operated from locations away from the devices with the use of remote controllers. Furthermore, nowadays there are also display devices that are remotely operated with the use of mobile devices instead of remote controllers. Such conventional display devices are disclosed in Japanese Patent Application Laid-Open Publication No. 2011-193426 and Japanese Patent Application Laid-Open Publication No. 2005-150831, for example.

The conventional display devices described in Japanese Patent Application Laid-Open Publication No. 2011-193426 and Japanese Patent Application Laid-Open Publication No. 2005-150831 are remotely operated by mobile phones that have remote control functions. Screens for remote operations are displayed on the display units of these mobile phones, and operators operate the display devices while looking at the screens of these mobile phones. The display devices are constituted such that control such as channel selection in televisions is made possible in this manner with simple operations performed by mobile phones.

With the conventional display devices described above, however, there are cases in which remote controllers or mobile devices for remote operations are lost, so there are concerns for the risk of requiring time and effort in looking for such remote controllers or mobile devices. Moreover, when mobile devices are used to remotely operate display devices, it is necessary to install and run applications or the like for remotely operating the display devices on the mobile devices themselves. For this reason, storage capacity for these applications must be secured in the mobile devices, and there is a possibility of requiring time and effort in running the applications as well.

### SUMMARY OF THE INVENTION

Preferred embodiments of the present invention provide a display device configured to be remotely operated with simple actions without requiring operation of any remote controller or mobile device.

A display device according to a preferred embodiment of the present invention includes a display unit; a detecting unit configured to detect an object of detection placed in the space in the normal direction of the screen of the display unit and also to deduce space information of the object of detection; an operating surface setting unit configured to use an operating surface setting object placed in the space in the normal direction of the screen of the display unit to set up a virtual operating surface that corresponds to the screen of the display unit; an input screen processing unit configured and programmed to generate an image signal pertaining to screen data to draw on the screen of the display unit a detection point that indicates the position of the object of detection within the operating surface; and an input point determining unit configured to identify that the object of detection within the frame of the operating surface has moved from the operator side toward the side of the display unit and reached the operating surface and to use the detection point pertaining to the arrival position of the object of detection that has arrived at the operating surface to determine an input point that indicates that a single point on the operating surface has been selected.

With this configuration, the display device sets up a virtual operating surface that corresponds to the screen of the display unit in the space between the display unit and the operator. Then, when the operator moves an object of detection such as a finger closer to the operating surface and causes it to reach the operating surface, the display device determines an input point that indicates that a single point on the operating surface has been selected at the arrival position of this finger that has arrived at the operating surface. That is, the point on the screen of the display unit corresponding to this input point is selected. Accordingly, the operator remotely performs input operations with simple actions without operating any remote controller or mobile device.

In addition, the operating surface setting unit is preferably configured to at least a portion of the body of an operator as the operating surface setting object to set up the operating surface.

With this configuration, an operating surface that corresponds to the screen of the display unit is set up using a body part of the operator. Accordingly, in the remote operation of the display device, there is no need for the operator to operate any remote controller or mobile device, and no other member is required, either. Furthermore, the operator is capable of quickly starting remote operation of the display device.

Moreover, the screen of the display unit preferably has a rectangular or substantially rectangular shape, and the operating surface setting unit is configured to set up the operating surface by associating at least a part of a hand of the operator with at least one side of the screen of the display unit.

With this configuration, one side of the screen of the display unit having a rectangular or substantially rectangular shape corresponds to a part of a hand of the operator, so the operator is capable of easily ascertaining the operating surface. Accordingly, the operator easily and quickly starts remote operation of the display device by extending a hand toward the display unit in order to set up the operating surface.

In addition, the screen of the display unit preferably has a rectangular or substantially rectangular shape, and the operating surface setting unit is configured to set up the operating surface by associating any single point on a hand of the operator with one of the vertexes of the screen of the display unit.

With this configuration, one of the vertexes of the screen of the display unit having a rectangular or substantially rectangular shape corresponds to a single point on a hand of the operator, so the operator is capable of easily ascertaining the operating surface. Accordingly, the operator easily and quickly starts remote operation of the display device by extending a hand for setting up the operating surface toward the display unit.

Furthermore, the operating surface setting unit preferably uses a stick member as the operating surface setting object to set up the operating surface.

With this configuration, the operating surface that corresponds to the screen of the display unit is set up by using a stick member. Accordingly, the operating surface is set up easily even when the operator cannot set up the operating surface by using a hand or finger, for example.

Moreover, the screen of the display unit preferably has a rectangular or substantially rectangular shape, and the operating surface setting unit is configured to set up the operating surface by associating at least a portion of the stick member with at least one side of the screen of the display unit.

With this configuration, one side of the screen of the display unit having a rectangular or substantially rectangular shape corresponds to a portion of the stick member, so the operator can easily ascertain the operating surface. Accordingly, the operator is capable of easily starting remote operation of the display device by placing the stick member configured to set up the operating surface between the operator and the display unit.

Various preferred embodiments of the present invention make it possible to provide a display device which is easily remotely operated with simple actions without operating any remote controller or mobile device.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a configuration diagram showing the display device according to a first preferred embodiment of the present invention.

FIG. 2 is a block diagram of the display device according to the first preferred embodiment of the present invention.

FIG. 3 is an explanatory diagram showing an input state of the display device according to the first preferred embodiment of the present invention, being an explanatory diagram as seen from above and behind an operator.

FIG. 4 is an explanatory diagram showing an input state of the display device according to the first preferred embodiment of the present invention, being an explanatory diagram as seen from a side of the operator.

FIG. 5 is a flowchart showing the input processing of the display device according to the first preferred embodiment of the present invention.

FIG. 6 is an explanatory diagram showing an input state of the display device according to a second preferred embodiment of the present invention, being an explanatory diagram as seen from above and behind an operator.

FIG. 7 is an explanatory diagram showing an input state of the display device according to the second preferred embodiment of the present invention, being an explanatory diagram as seen from a side of the operator.

FIG. 8 is an explanatory diagram showing an input state of the display device according to a third preferred embodiment of the present invention, being an explanatory diagram as seen from above and behind an operator.

FIG. 9 is an explanatory diagram showing an input state of the display device according to the third preferred embodiment of the present invention, being an explanatory diagram as seen from a side of the operator.

### DETAILED DESCRIPTION OF THE PREFERRED EMBODIMENTS

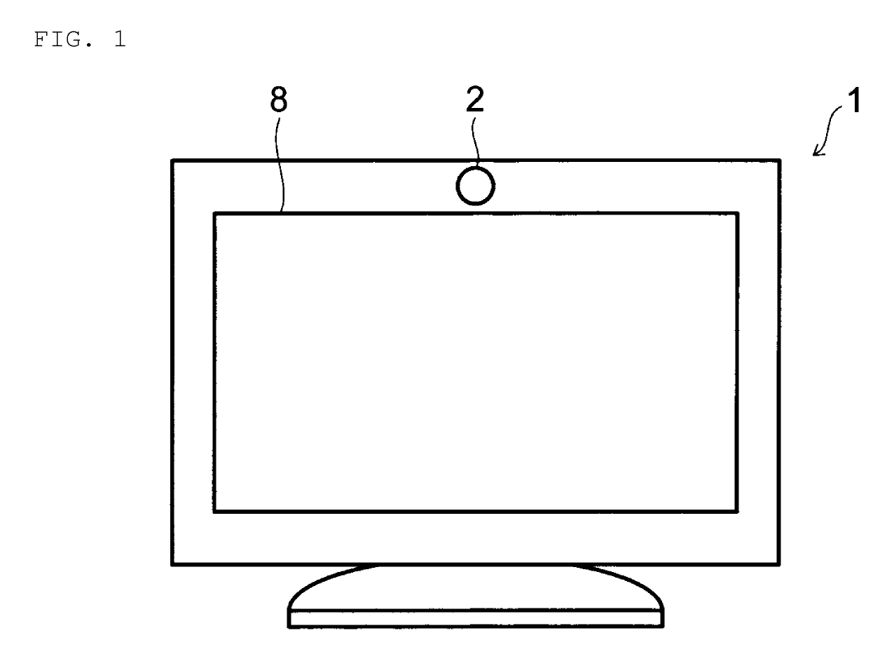

Preferred embodiments of the present invention will be described below based on FIGS. 1 through 9.

### First Preferred Embodiment

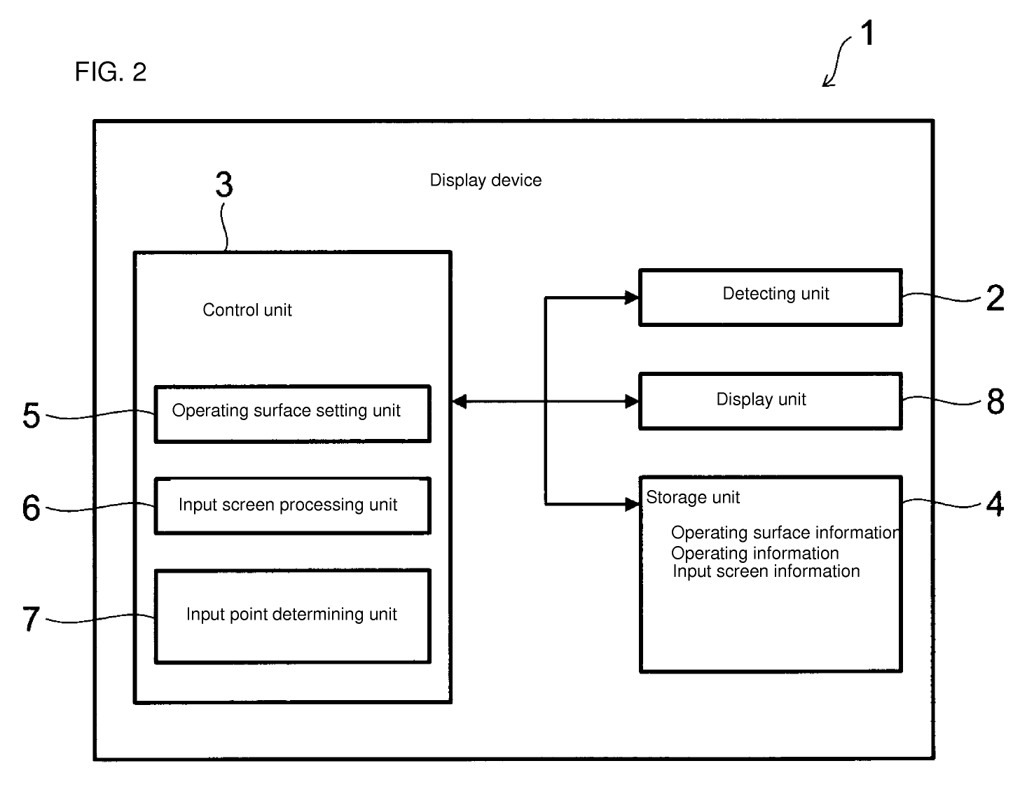

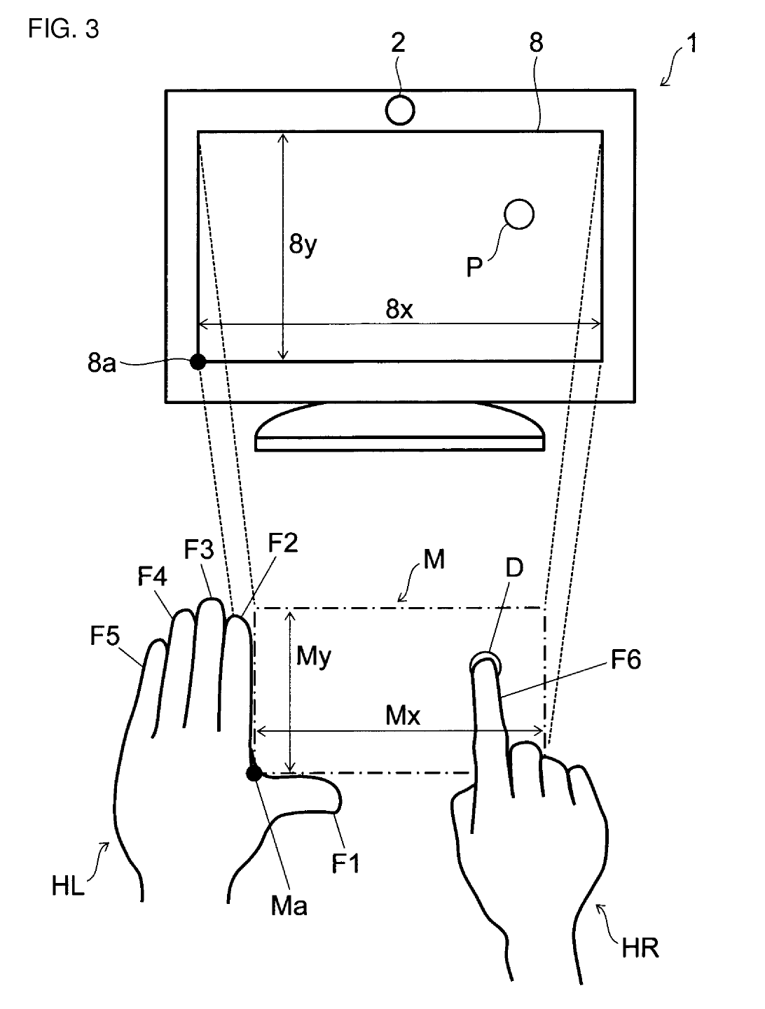

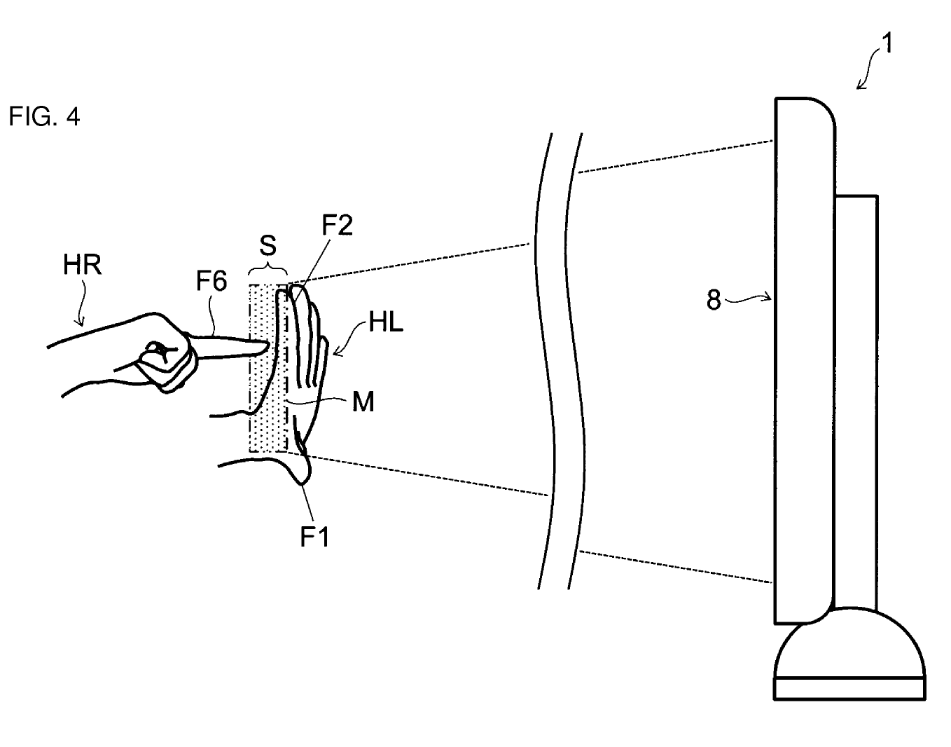

First, the configuration of the display device according to a first preferred embodiment of the present invention will be described using FIGS. 1 through 4. FIG. 1 is a configuration diagram showing the display device. FIG. 2 is a block diagram of the display device. FIG. 3 and FIG. 4 are explanatory diagrams showing an input state of the display device, being an explanatory diagram as seen from above and behind an operator and an explanatory diagram as seen from a side of the operator, respectively. Note that the right side in FIG. 3 is the right side for the operator, while the left side is the left side for the operator. The near side in the direction of depth with respect to the plane of the page in FIG. 3 is the operator side, while the back side in the direction of depth is the display unit side. The left side in FIG. 4 is the operator side, while the right side is the display unit side.

As shown in FIGS. 1 and 2, a display device 1 preferably includes a detecting unit 2, a control unit 3, a storage unit 4, an operating surface setting unit 5, an input screen processing unit 6, an input point determining unit 7, and a display unit 8. Note that the display device 1 is a video receiver that reproduces broadcast programs from broadcasting signals provided through television stations and the internet, for example, and besides the constituent elements, it is equipped with constituent elements that are not shown in the figures and pertain to reproducing broadcast programs, but the description thereof will be omitted here. Furthermore, the display device 1 also is configured to define and function as an input device with which an operator freely manipulates the content displayed on the display unit 8.

The detecting unit 2 includes a sensor which is provided in the main body of the display device 1 so as to face the normal direction of the screen of the display unit 8, i.e., the direction in which a viewer (operator) of the display device 1 is located, and which has optical, electromagnetic, acoustic, or thermal detection capability, for example. The detecting unit 2 is configured to detect an object of detection placed in the space in the normal direction of the screen of the display unit 8 and determine the space information of this object of detection, for example, the position and shape of the object of detection and the distance to the object of detection. For instance, the detecting unit 2 detects the entirety of the operator as well as body parts of the operator, items held in the hands of the operator, and the like and also determines the space information thereof.

The control unit 3 preferably includes an operational processing unit (not shown) and other electronic components and, based on programs and data that are input and stored in advance in the storage unit 4 or the like, is configured and programmed to obtain information from the various constituent elements of the display device 1 and also control the actions of these constituent elements, thus realizing the series of detection processing of the object of detection, screen processing, and display processing. The control unit 3 preferably is configured and programmed to define and include the operating surface setting unit 5, the input screen processing unit 6, and the input point determining unit 7. Note that the configuration here is such that the control unit 3 preferably is configured and programmed to define and include the operating surface setting unit 5, the input screen processing unit 6, and the input point determining unit 7, but a configuration is also possible in which the operating surface setting unit 5, the input screen processing unit 6, and the input point determining unit 7 are provided separately from the control unit 3.

The operating surface setting unit 5 is configured to set up a virtual operating surface M that corresponds to the screen of the display unit 8 between the display unit 8 and the operator as shown in FIGS. 3 and 4. For example, the operating surface M preferably has a rectangular or substantially rectangular shape similar to the screen of the display unit 8. The operating surface setting unit 5 sets up the operating surface M by using the left hand HL, for example, which is a body part of the operator, placed in the space between the display unit 8 and the operator as the operating surface setting object. The operator performs input operations pertaining to the content displayed on the display unit 8 on this operating surface M by using the index finger F6 or the like of the right hand HR.

Information pertaining to the use of the left hand HL as the operating surface setting object is stored in advance in the storage unit 4 as the operating surface information. In this case, it is necessary for the operator to face the palm of the left hand HL toward the display unit 8, to extend the four fingers F2 through F5, excluding the thumb F1, upward, and to extend the thumb F1 toward the right side of the operator as shown in FIGS. 3 and 4. As a result, the operating surface setting unit 5 sets up the rectangular or substantially rectangular virtual operating surface M defined by the left hand HL that is open as shown in FIG. 3 based on the operating surface information about the use of the left hand HL stored in the storage unit 4 and the space information of the left hand HL detected by the detecting unit 2.

In the setting of the operating surface M by the operating surface setting unit 5, the storage unit 4 stores operator information and input screen information in addition to the operating surface information. For example, the operator information includes information about the operator such as the dominant hand and the shape and size of the hands. The input screen information includes information such as the shape and size of the display unit 8. Based on the ratio of the length 8y in the vertical direction and the length 8x in the horizontal direction of the screen of the display unit 8 that are stored in advance to the length My from the base of the thumb F1 to the tip end of the index finger F2 of the left hand HL of the operator that is stored in advance, the operating surface setting unit 5 deduces the length Mx in the horizontal direction of the operating surface M and thus sets the size of the operating surface M. The operating surface M is set up such that the lower left vertex Ma of the operating surface M coincides with the portion of the base of the thumb F1 between the thumb F1 and the index finger F2 of the left hand HL of the operator. The lower left vertex Ma of the operating surface M corresponds to the lower left vertex 8a of the screen of the display unit 8.

Note that the operator information is not absolutely required as the information stored in advance in the storage unit 4. The size of the hands of the operator (for example, the length My from the base of the thumb F1 to the tip end of the index finger F2 of the left hand HL) preferably is measured when the palm of a hand faces the display unit 8 at the start of input. In order to increase the precision of the setting of the size of the operating surface M, however, it is preferable to have the size of the hands of the operator stored in advance in the storage unit 4 as described above.

The input screen processing unit 6 specifies a detection point D that indicates the position of an object of detection within the operating surface M based on the information pertaining to the operating surface M set by the operating surface setting unit 5 and the space information of the object of detection detected by the detecting unit 2. Here, the input screen processing unit 6 sets up, as the detection area S of the object of detection, an area within the operating surface M and within the space that defines a rectangular or substantially rectangular parallelepiped shape obtained from the trajectory of projection of the operating surface M from a specified distance away from the operating surface M toward the operator. Then, the input screen processing unit 6 identifies, from among a plurality of objects of detection detected within the detection area S, a single point closest to the display unit 8, for example, as the object of detection.

In cases where the left hand HL is used to set up the operating surface M as shown in FIGS. 3 and 4, the operator generally uses the right hand HR to perform input operations on the content displayed on the display unit 8. By doing this, when the input point is a single point as in the case with performing tap input or drag input, for example, the input screen processing unit 6 specifies, as the detection point D, the position of the fingertip of the index finger F6 of the right hand HR extended by the operator toward the operating surface M and detected within the detection area S. Then, the input screen processing unit 6 generates an image signal pertaining to the screen data for drawing the detection point D that indicates the position of the object of detection within the operating surface M on the screen of the display unit 8.

The input point determining unit 7 identifies that the object of detection within the frame of the operating surface M has moved from the operator side toward the side of the display unit 8 and reached the operating surface M. Moreover, the input point determining unit 7 uses the detection point D pertaining to the arrival position of the object of detection that has arrived at the operating surface M to determine the input point that indicates that a single point on the operating surface M has been selected. Note that “determination of the input point” mentioned here is equivalent to a state in which a finger or the like has come into contact at a single point on a touch panel by tap input or drag input or a state of being clicked with a mouse as a pointing device.

In addition, information about habits or the like regarding operator's input, for example, may also be stored as the operator information in the storage unit 4. For instance, it is possible to have the operator use the operating surface M to perform tap, drag, and other input methods beforehand and to use stored information about habits and tendencies pertaining to these operations to set up and use the conditions for the position of the input point as the operator information.

The display unit 8 preferably is configured to use, for video display, a rectangular or substantially rectangular liquid crystal panel having a plate-shaped or substantially plate-shaped configuration, for example, to display content provided from television stations or the like on the screen. Furthermore, the display unit 8 displays screen data on the screen based on image signals pertaining to the input screen that are received from the input screen processing unit 6. Specifically, the display unit 8 displays on the screen a pointer P that corresponds to the detection point D which is the fingertip of the index finger F6 of the right hand HR of the operator as shown in FIG. 3. Note that if the operator moves the index finger F6 of the right hand HR upward, downward, leftward, and rightward within the detection area S, for example, the pointer P on the screen of the display unit 8 also moves upward, downward, leftward, and rightward in conjunction with this movement based on the processing by the input screen processing unit 6.

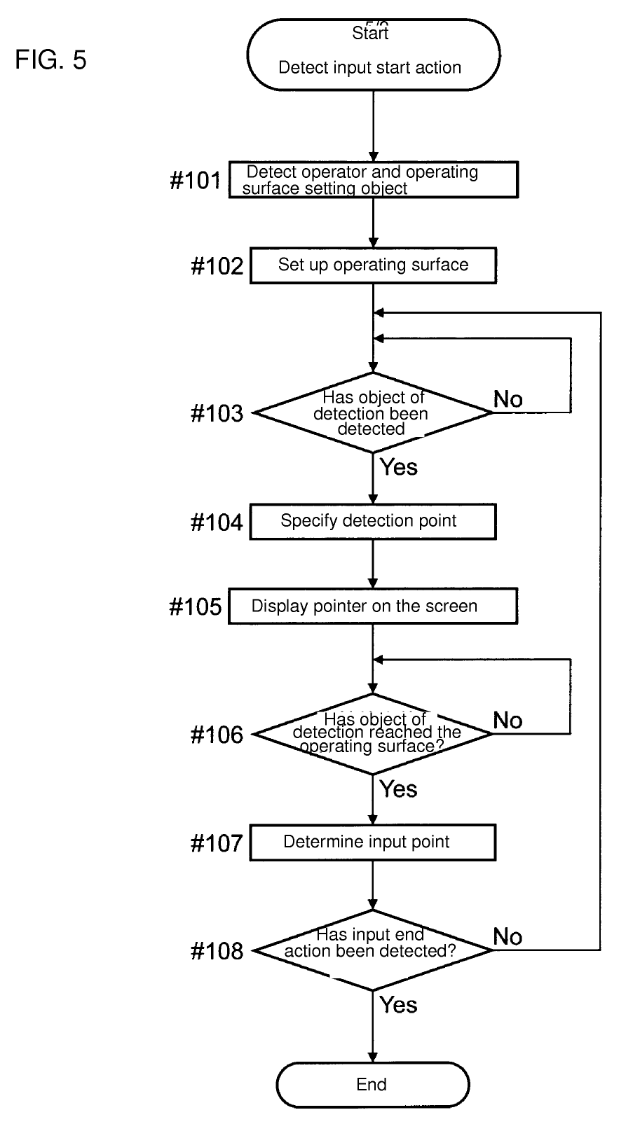

Next, the input processing in the display device 1 will be described with respect to the process flow shown in FIG. 5 with reference to FIGS. 3 and 4. FIG. 5 is a flowchart showing the input processing in the display device 1.

Here, a description will be given by citing an example of an input to select a single point on the screen of the display unit 8 using the display device 1.

When performing an input to select a single point on the screen of the display unit 8 in the display device 1, the operator first indicates to the display device 1 an input start action that signals the start of an input operation. The input start action may, for example, simply be to open the left hand HL and to face the palm toward the display unit 8 as shown in FIGS. 3 and 4, and this action is stored in advance in the storage unit 4 or the like.

When the input start action is detected (Start in FIG. 5), the control unit 3 causes the detecting unit 2 to detect the operator and the operating surface setting object, i.e., the left hand HL of the operator (step #101). Then, the operating surface setting unit 5 sets up a rectangular or substantially rectangular virtual operating surface M defined by the left hand HL that is open as shown in FIG. 3 based on the operating surface information about the use of the left hand HL stored in the storage unit 4 and the space information of the left hand HL detected by the detecting unit 2 (step #102).

Next, based on the information from the input screen processing unit 6, the control unit 3 determines whether or not an object of detection can be detected in the detection area S (step #103). If no object of detection can be detected (No in step #103), the control unit 3 determines again whether or not an object of detection can be detected.

If an object of detection, i.e., the fingertip of the index finger F6 of the right hand HR, can be detected in the detection area S (Yes in step #103), the input screen processing unit 6 specifies the detection point D that indicates the position of the fingertip of the index finger F6 of the right hand HR within the operating surface M based on the information pertaining to the operating surface M and the space information about the fingertip of the index finger F6 of the right hand HR (step #104). Then, the input screen processing unit 6 outputs an image signal to draw the detection point D on the screen of the display unit 8, and the display unit 8 displays a pointer P that corresponds to the detection point D on the screen as shown in FIG. 3 based on this image signal (step #105).

Next, based on the information from the input point determining unit 7, the control unit 3 determines whether or not the index finger F6 of the right hand HR within the frame of the operating surface M has moved from the operator side toward the side of the display unit 8 and reached the operating surface M (step #106). If the arrival of the index finger F6 at the operating surface M cannot be detected (No in step #106), the control unit 3 determines again whether or not the arrival can be detected.

If the arrival of the index finger F6 of the right hand HR at the operating surface M can be detected (Yes in step #106), the input point determining unit 7 uses the detection point D pertaining to the arrival position of the index finger F6 of the right hand HR that has arrived at the operating surface M to determine an input point that indicates that a single point on the operating surface M has been selected (step #107). At this time, if the content offers an object of selection such as a key, button, image, file, or data at the location of the pointer P that corresponds to the input point, then this object of selection is selected based on the input processing in the display device 1.

Next, the control unit 3 determines whether or not an input end action can be detected (step #108). The input end action may, for example, simply be to stop opening the left hand HL and facing the palm toward the display unit 8 as shown in FIGS. 3 and 4, and this action is stored in advance in the storage unit 4 or the like. If no input end action can be detected (No in step #108), the procedure returns to step #103, and the control unit 3 determines again whether or not an object of detection can be detected in the detection area S.

If an input end action can be detected (Yes in step #108), the control unit 3 terminates the input processing in the display device 1 (End in FIG. 5). Note that in the input processing described using FIG. 5, if the operator withdraws the left hand HL which is the operating surface setting object from the front portion of the display unit 8, for example, before an input point is determined in step #107, then this processing is aborted.

As was described above, the display device 1 according to the present preferred embodiment of the present invention preferably includes the display unit 8, the detecting unit 2 configured to detect an object of detection placed in the space in the normal direction of the screen of the display unit 8 and also deduce space information of the object of detection, the operating surface setting unit 5 configured to use an operating surface setting object placed in the space in the normal direction of the screen of the display unit 8 to set up a virtual operating surface M that corresponds to the screen of the display unit 8, the input screen processing unit 6 configured to generate an image signal pertaining to the screen data for drawing on the screen of the display unit 8 a detection point D that indicates the position of the index finger F6 of the right hand HR constituting the object of detection within the operating surface M, and the input point determining unit 7 configured to identify that the index finger F6 of the right hand HR within the frame of the operating surface M has moved from the operator side toward the side of the display unit 8 and reached the operating surface M and uses the detection point D pertaining to the arrival position of the index finger F6 of the right hand HR that has arrived at the operating surface M to determine an input point that indicates that a single point on the operating surface M has been selected.

With this configuration, the display device 1 sets up a virtual operating surface M that corresponds to the screen of the display unit 8 in the space between the display unit 8 and the operator. Then, when the operator moves a finger closer to the operating surface M and causes it to reach the operating surface M, the display device 1 determines an input point that indicates that a single point on the operating surface M has been selected at the arrival position of this finger which has arrived at the operating surface M. That is, the point on the screen of the display unit 8 corresponding to this input point (location of the pointer P) is selected. Accordingly, the operator performs an input operation remotely with a simple action without operating any remote controller or mobile device.

Moreover, the display device 1 is configured such that the operating surface setting unit 5 sets up an operating surface M using the left hand HL of the operator as the operating surface setting object. As a result, an operating surface M that corresponds to the screen of the display unit 8 is set up with the use of the left hand HL of the operator. Accordingly, in the remote operation of the display device 1, the operator does not need to operate any remote controller or mobile device, and no other member is required, either. In addition, the operator can quickly start remotely operating the display device 1.

Furthermore, in the display device 1, the screen of the display unit 8 preferably has a rectangular or substantially rectangular shape, and the operating surface setting unit 5 preferably sets up an operating surface M by associating the part of the left hand HL of the operator from the base of the thumb F1 to the tip end of the index finger F2 with one side of the screen of the display unit 8 extending in the vertical direction. With this configuration, the operator easily ascertains the operating surface M. Accordingly, the operator quickly and easily starts remotely operating the display device by opening the left hand HL and extending it toward the display unit 8 in order to set up an operating surface M.

### Second Preferred Embodiment

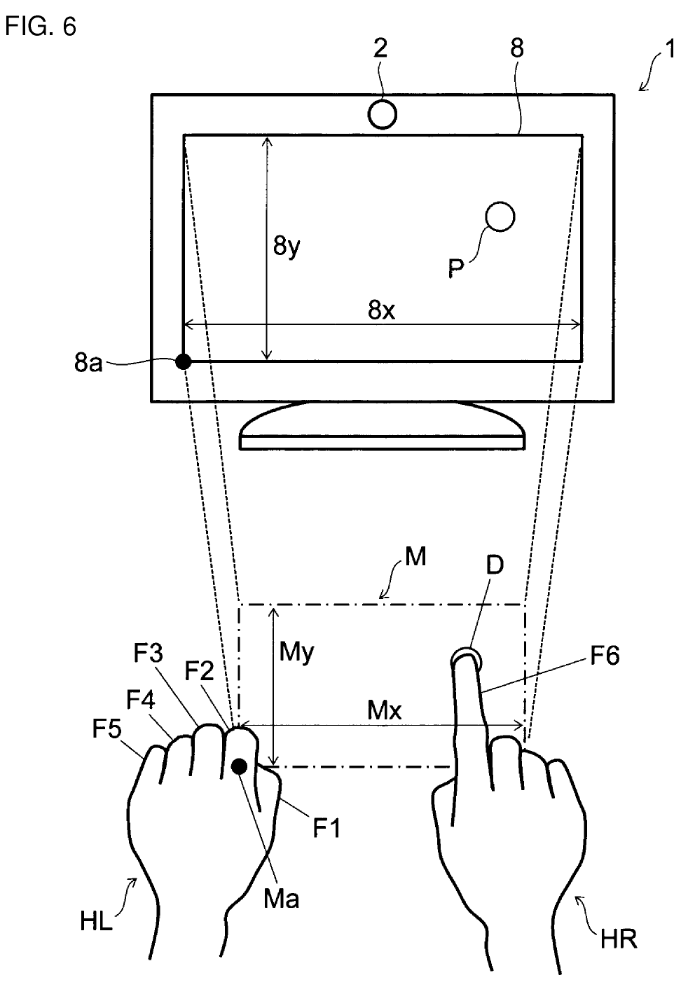

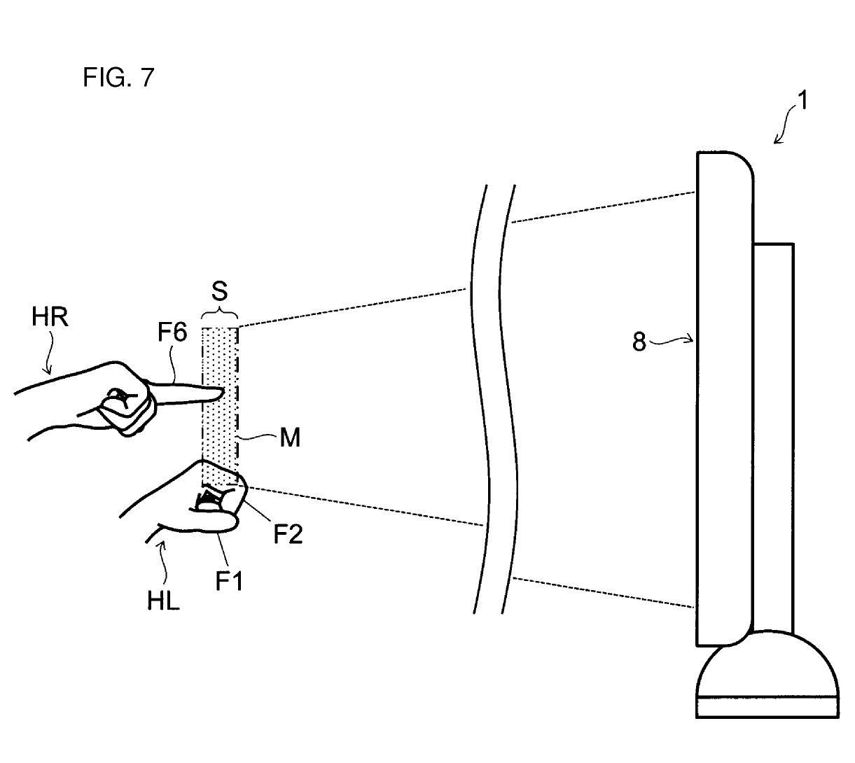

Next, the configuration of the display device according to a second preferred embodiment of the present invention will be described by using FIGS. 6 and 7. FIGS. 6 and 7 are explanatory diagrams showing an input state of the display device, being an explanatory diagram as seen from above and behind an operator and an explanatory diagram as seen from a side of the operator, respectively. Note that the basic configuration of this preferred embodiment is preferably the same as in the first preferred embodiment described above, so constituent elements that are in common with the first preferred embodiment are given the same symbols, and the description of the figures and explanations thereof will be omitted. Moreover, the right side in FIG. 6 is the right side for the operator, while the left side is the left side for the operator. The near side in the direction of depth with respect to the plane of the page in FIG. 6 is the operator side, while the back side in the direction of depth is the display unit side. The left side in FIG. 7 is the operator side, while the right side is the display unit side.

In the second preferred embodiment, the operating surface setting unit 5 sets up an operating surface M by using the left hand HL, which is a body part of the operator, that is formed into a clenched fist, for example, as the operating surface setting object as shown in FIGS. 6 and 7. Information pertaining to the use of the left hand HL that is formed into a clenched first as the operating surface setting object is stored in advance in the storage unit 4 as operating surface information. By doing this, the operating surface setting unit sets up a rectangular or substantially rectangular virtual operating surface M defined by the left hand HL that is formed into a clenched first as shown in FIG. 6 based on the operating surface information about the use of the clenched left hand HL that is stored in the storage unit 4 and the space information of the left hand HL detected by the detecting unit 2.

Note that an operating surface M is set up such that the lower left vertex Ma of the operating surface M coincides with a specified point of the clenched left hand HL of the operator that is stored in advance in the storage unit 4 as the operating surface information. The lower left vertex Ma of the operating surface M corresponds to the lower left vertex 8a of the screen of the display unit 8. In addition, with regard to the size of the operating surface M as well, the length Mx in the horizontal direction and the length My in the vertical direction of the operating surface M are set based on the operating surface information stored in the storage unit 4.

As was described above, the display device 1 is such that the screen of the display unit 8 has a rectangular or substantially rectangular shape and such that the operating surface setting unit 5 sets up an operating surface M by associating any single point of the clenched left hand HL of the operator, for example, with the lower left vertex 8a of the screen of the display unit 8. This configuration makes it possible for the operator to easily ascertain the operating surface M. Accordingly, the operator can easily and quickly start remotely operating the display device 1 by forming a hand for setting the operating surface M into a clenched first and extending it toward the display unit 8.

This method for setting an operating surface M is effective when the size of the screen of the display unit 8 is not so large to begin with or when the operator is far away from the display unit 8 and the size of the screen of the display unit 8 occupying the visual field of the operator is not so large. Furthermore, this method is also effective in situations such as when the operator is holding something in the left hand HL and cannot let it go.

### Third Preferred Embodiment

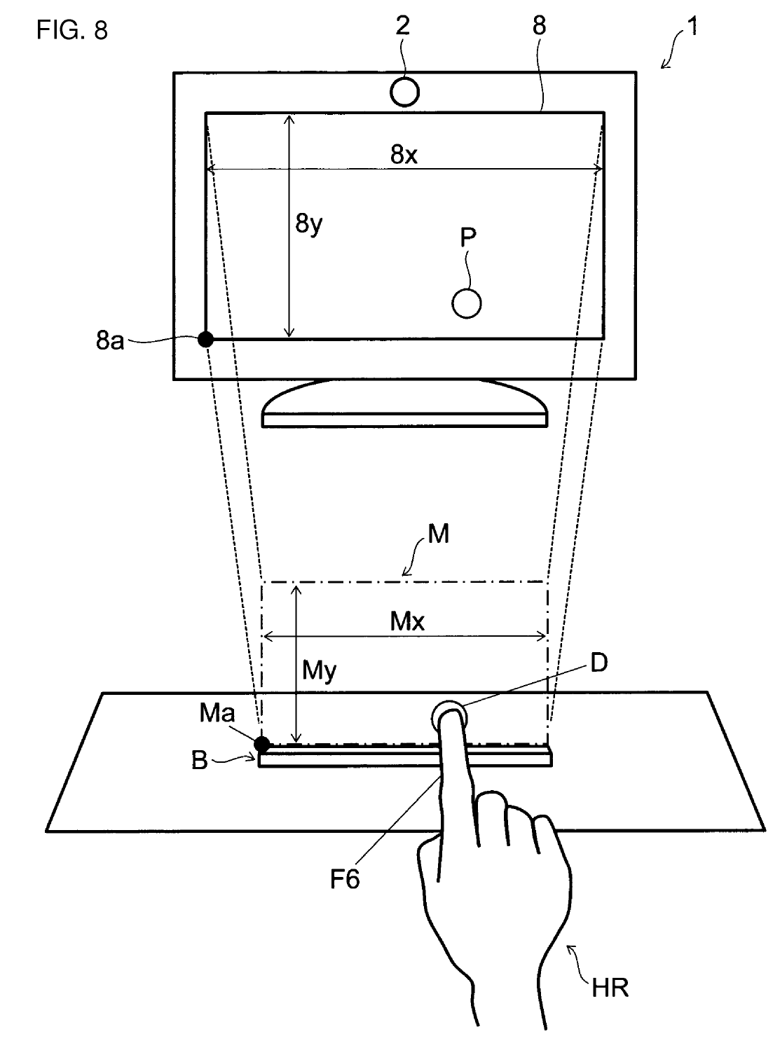

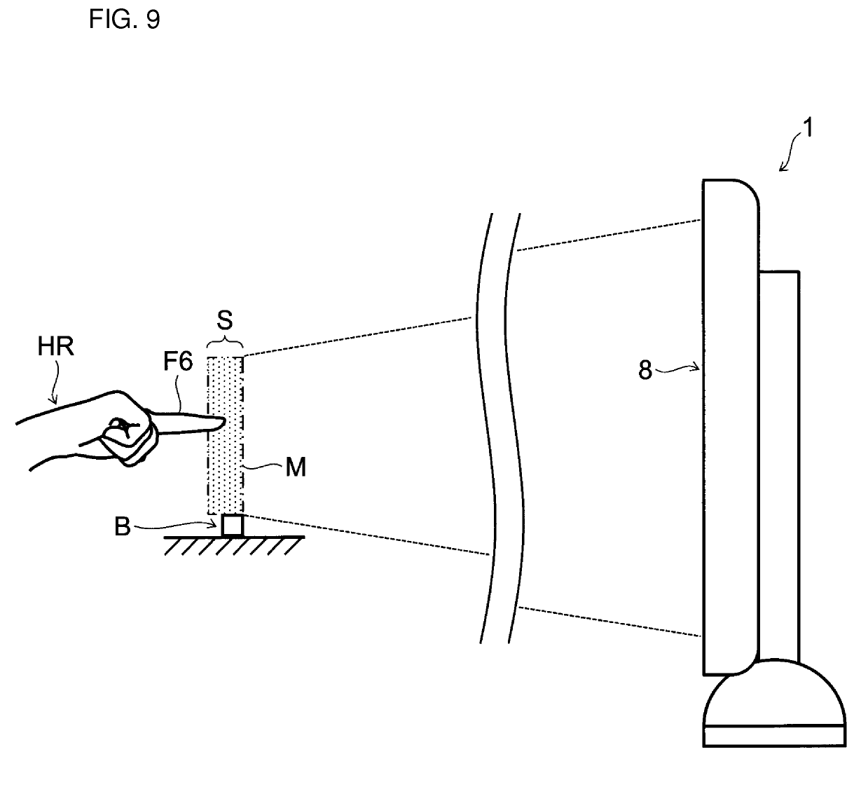

Next, the configuration of the display device according to a third preferred embodiment of the present invention will be described by using FIGS. 8 and 9. FIGS. 8 and 9 are explanatory diagrams showing an input state of the display device, being an explanatory diagram as seen from above and behind an operator and an explanatory diagram as seen from a side of the operator, respectively. Note that the basic configuration of this preferred embodiment is preferably the same as in the first preferred embodiment described previously, so constituent elements that are in common with the first preferred embodiment are given the same symbols, and the description of the figures and explanations thereof will be omitted. Moreover, the right side in FIG. 8 is the right side for the operator, while the left side is the left side for the operator. The near side in the direction of depth with respect to the plane of the page in FIG. 8 is the operator side, while the back side in the direction of depth is the display unit side. The left side in FIG. 9 is the operator side, while the right side is the display unit side.

In the third preferred embodiment, the operating surface setting unit 5 sets up an operating surface M by using, as the operating surface setting object, a stick member B placed on the floor or a desk so as to be parallel or substantially parallel to the screen of the display unit 8 as shown in FIGS. 8 and 9. Information about the use of the stick member B as the operating surface setting object is stored in advance in the storage unit 4 as operating surface information. By doing this, the operating surface setting unit 5 sets up a rectangular or substantially rectangular virtual operating surface M defined by the stick member B as shown in FIG. 8 based on the operating surface information about the use of the stick member B stored in the storage unit 4 and the space information of the stick member B detected by the detecting unit 2.

Note that an operating surface M is set up such that the lower left vertex Ma of the operating surface M coincides with the left end portion of the stick member B as seen from the operator side. The lower left vertex Ma of the operating surface M corresponds to the lower left vertex 8a of the screen of the display unit 8. In addition, with regard to the size of the operating surface M, the operating surface M is set up based on the operating surface information stored in the storage unit 4 such that the bottom side of the screen of the display unit 8, i.e., the bottom side of the operating surface M, corresponds to the entirety of the stick member B that extends parallel or substantially parallel to the screen of the display unit 8. The length My in the vertical direction of the operating surface M is set from the ratio with the length Mx in the horizontal direction (the length of the entire stick member B) based on the screen information of the display unit 8.

As was described above, the operating surface setting unit 5 sets up an operating surface M by using the stick member B as the operating surface setting object, so even when the operator cannot set up an operating surface M by using a hand or finger, for example, it is possible to easily set up the operating surface M.

Furthermore, the display device 1 is such that the screen of the display unit 8 has a rectangular or substantially rectangular shape and such that the operating surface setting unit 5 sets up an operating surface M by associating the entirety of the stick member B with the bottom side of the screen of the display unit 8. This configuration makes it possible for the operator to easily ascertain the operating surface M. Accordingly, the operator can easily start remotely operating the display device 1 by placing the stick member B configured to set the operating surface M between the operator and the display unit 8.

This method for setting an operating surface M allows the operator to be able to perform input operations using the display device 1 even when it is not possible to use hands because of sickness or injuries, so this method is effective.

Preferred embodiments of the present invention were described above, but the scope of the present invention is in no way limited to this. Preferred embodiments to which various modifications are made can be carried out within the scope that does not depart from the gist of the present invention.

In the first preferred embodiment, for example, with regard to the left hand HL as the operating surface setting object, preferably four fingers F2 through F5, excluding the thumb F1, are extended upward, and the thumb F1 is extended toward the right of the operator. However, it is also possible to extend the four fingers F2 through F5, excluding the thumb F1, toward the right of the operator and to extend the thumb F1 upward. Moreover, the right hand HR may be used as the operating surface setting object in the first preferred embodiment.

In addition, in the second preferred embodiment, the left hand HL that is formed into a clenched first is preferably used as the operating surface setting object to set up an operating surface M, but the operating surface setting object is in no way limited to a clenched fist. Other modes are also possible as long as an operating surface M can be set up by making association of any single point of a hand with one of the vertexes of the screen of the display unit 8 without the operator opening the hand. Furthermore, the orientation of the clenched left hand HL in the second preferred embodiment is not limited to the orientation shown as an example in FIGS. 6 and 7. Moreover, the right hand HR may also be used as the operating surface setting object in the second preferred embodiment.

Furthermore, in the third preferred embodiment, for the stick member B used as the operating surface setting object, a member with the simplest structure that extends straight is described as an example, but the member is not limited to this. For instance, a member such as a pencil, pen, or chopstick can be used as the stick member B. Moreover, the stick member may also have an L-shaped structure, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A display device comprising:
a display unit;
a detecting unit configured to detect an object of detection placed in a space in a normal direction of a screen of the display unit and to deduce space information of the object of detection;
an operating surface setting unit configured to use an operating surface setting object placed in the space in the normal direction of the screen of the display unit to set up a virtual operating surface that corresponds to the screen of the display unit;
an input screen processing unit configured to generate an image signal pertaining to screen data to draw on the screen of the display unit a detection point that indicates a position of the object of detection within the operating surface; and
an input point determining unit configured to identify that the object of detection within a frame of the operating surface has moved from an operator side toward a side of the display unit and reached the operating surface and to use the detection point pertaining to an arrival position of the object of detection that has arrived at the operating surface to determine an input point that indicates that a single point on the operating surface has been selected.

2. The display device according to claim 1, wherein the operating surface setting unit is configured to use at least a part of a body of an operator as the operating surface setting object to set up the operating surface.

3. The display device according to claim 2, wherein
the screen of the display unit has a rectangular or substantially rectangular shape; and
the operating surface setting unit is configured to set up the operating surface by associating at least a part of a hand of the operator with at least one side of the screen of the display unit.

4. The display device according to claim 2, wherein
the screen of the display unit has a rectangular or substantially rectangular shape; and
the operating surface setting unit is configured to set up the operating surface by associating any single point on a hand of the operator with one of vertexes of the screen of the display unit.

5. The display device according to claim 1, wherein the operating surface setting unit is configured to use a stick member as the operating surface setting object to set up the operating surface.

6. The display device according to claim 5, wherein
the screen of the display unit has a rectangular or substantially rectangular shape; and
the operating surface setting unit is configured to set up the operating surface by associating at least a portion of the stick member with at least one side of the screen of the display unit.

7. The display device according to claim 1, wherein the detecting unit includes a sensor arranged to face the normal direction of the screen of the display unit.

8. The display device according to claim 1, wherein the detecting unit is configured to detect an entirety of the operator, body parts of the operator, and items held in a hand of the operator and to determine space information thereof.

9. The display device according to claim 1, further comprising a control unit including a processor configured and programmed to define the operating surface setting unit, the input screen processing unit, and the input point determining unit.

10. The display device according to claim 1, wherein the operating surface setting unit is configured to set up the virtual operating surface defined by a hand of an operator based on operating surface information about use of the hand stored in a storage unit and space information of the hand detected by the detecting unit.

11. The display device according to claim 1, wherein the operating surface setting unit is configured to set up the virtual operating surface by using a hand of an operator.

12. The display device according to claim 11, wherein the hand of the operator is in a form of a clenched fist.

13. The display device according to claim 5, wherein the stick is one of a pencil, a pen, and a chopstick.

14. A display device comprising:
a display unit;
a detecting unit configured to detect an object of detection placed in a space in a normal direction of a screen of the display unit and to deduce space information of the object of detection; and
a control unit including a processor configured and programmed to define:
an operating surface setting unit configured to use an operating surface setting object placed in the space in the normal direction of the screen of the display unit to set up a virtual operating surface that corresponds to the screen of the display unit;
an input screen processing unit configured to generate an image signal pertaining to screen data to draw on the screen of the display unit a detection point that indicates a position of the object of detection within the operating surface; and
an input point determining unit configured to identify that the object of detection within a frame of the operating surface has moved from an operator side toward a side of the display unit and reached the operating surface and to use the detection point pertaining to an arrival position of the object of detection that has arrived at the operating surface to determine an input point that indicates that a single point on the operating surface has been selected.

15. The display device according to claim 14, wherein the operating surface setting unit is configured to use at least a part of a body of an operator as the operating surface setting object to set up the operating surface.

16. The display device according to claim 15, wherein
the screen of the display unit has a rectangular or substantially rectangular shape; and
the operating surface setting unit is configured to set up the operating surface by associating at least a part of a hand of the operator with at least one side of the screen of the display unit.

17. The display device according to claim 15, wherein
the screen of the display unit has a rectangular or substantially rectangular shape; and
the operating surface setting unit is configured to set up the operating surface by associating any single point on a hand of the operator with one of vertexes of the screen of the display unit.

18. The display device according to claim 14, wherein the operating surface setting unit is configured to use a stick member as the operating surface setting object to set up the operating surface.

19. The display device according to claim 18, wherein
the screen of the display unit has a rectangular or substantially rectangular shape; and
the operating surface setting unit is configured to set up the operating surface by associating at least a portion of the stick member with at least one side of the screen of the display unit.

20. The display device according to claim 14, wherein the detecting unit includes a sensor arranged to face the normal direction of the screen of the display unit.
